(19) United States
(12) Patent Application Publication
(10) Pub. No.: US 2012/0165420 A1
(43) Pub. Date: Jun. 28, 2012

(54) Process for Preparing Composite Membranes

(75) Inventors: Vinodnarain Veedprakash Bhikhi, Tilburg (NL); Johannes Adrianus Wilhelmus Van Engelen, Tilburg (NL)

(73) Assignee: Fujifilm Manufacturing Europe B.V, Tilburg (NL)

(21) Appl. No.: 13/393,448

(22) PCT Filed: Aug. 11, 2010
(86) PCT No.: PCT/GB2010/051331

§ 371 Date: Feb. 29, 2012

(30) Foreign Application Priority Data
Sep. 1, 2009 (GB) 0915109.3

(51) Int. Cl. C08J 5/22; B01D 35/06; B01D 61/42; B01D 61/46; C08F 2/46; B05D 3/06

(52) U.S. Cl. 521/27; 427/487; 204/627; 204/630; 204/665

(57) ABSTRACT

A process for preparing a composite membrane comprising acidic and/or basic groups comprising the following steps:
(i) applying a curable composition to a support; and
(ii) curing the composition to form a membrane;
   wherein the curable composition comprises:
(a) 18 to 78 wt % crosslinking agent(s) having at least two acrylic groups;
(b) 20 to 80 wt % curable compound(s) having one or more acidic or basic groups or groups which are convertible to acidic or basic groups;
(c) 2 to 30 wt % solvent(s); and
(d) 0 to 10 wt % photoinitiator(s).

The membranes are particularly useful for water purification or for the generation of electricity from two streams differing in salt concentration.

This invention relates to composite membranes, to processes for their preparation and to the use of such membranes in ion exchange processes.

Ion exchange membranes are useful in a number of applications, including electrodeionisation (EDI), continuous electrodeionisation (CEDI), electrodialysis reversal (EDR) and flow through capacitors (FTC) for the purification of water, and reverse electrodialysis (RED) where electricity is generated from two streams differing in salt concentration separated by an ion-permeable membrane.

EDI is a water treatment process wherein ions are removed from aqueous liquids using a membrane and an electrical potential to effect ion transport. It differs from other water purification technologies, such as conventional ion exchange, in that it is does not require the use of chemicals such as acids or caustic soda. EDI can be used to produce ultra pure water.

EDR is an electrochemical separation process that removes ions and other charged species from water and other fluids. EDR uses small quantities of electricity to transport these species through membranes composed of ion exchange material to create separate purified and concentrated streams. Ions are transferred through the membranes by means of direct current voltage and are removed from the feed water as the current drives the ions through the membranes to desalinate the process stream. EDR is a suitable technique for producing drinking water.

FTC's are an efficient means of chemical-free Total Dissolved Solids reduction using electrically charged carbon electrodes to remove ions.

One of the important problems in the production of ion exchange membranes for (C)EDI, EDR, FTC and RED is achieving thin membranes with minimal defects. Desirably the membranes have good permselectivity and low resistance. Additionally the membranes are desired to be strong, while at the same time being flexible. Flexibility is required for membranes which are to be wound into tight circumferential structures. The membranes also need to retain their physical integrity over an extended period of time. Desirably the method used to prepare the membranes does not result in excessive curl.

Membrane users require the lowest prices available, which means production processes for the membranes are ideally inexpensive and the membranes should be easily capable of mass production.

U.S. Pat. No. 4,923,611 describes a process for preparing ion exchange membranes for electrodialysis. The process was slow and energy intensive, requiring 16 hours to cure the membrane and temperatures of 80° C. Similarly the processes used in U.S. Pat. No. 4,587,269 and U.S. Pat. No. 5,203,982 took 17 hours at 80° C.

U.S. Pat. No. 4,822,471 describes the manufacturing of ion exchange membranes from a solution void of any non-polymerizable solvents. The process required 12 hours at 80° C.

The present invention seeks to provide a cost effective process for providing membranes suitable for use in the abovementioned applications.

According to a first aspect of the present invention there is provided a process for preparing a composite membrane comprising acidic and/or basic groups comprising the following steps:
(i) applying a curable composition to a support; and
(ii) curing the composition to form a membrane;
   wherein the curable composition comprises:
(a) 18 to 78 wt % crosslinking agent(s) having at least two acrylic groups;
(b) 20 to 80 wt % curable compound(s) having one or more acidic or basic groups or groups which are convertible to acidic or basic groups;
(c) 2 to 30 wt % solvent(s); and
(d) 0 to 10 wt % photoinitiator(s).

A very low content of crosslinking agent (e.g. lower than 18 wt %) is not desirable because a rather weak structure may result. A very high content of crosslinking agent (e.g. higher than 78 wt %) is not desirable because a too rigid structure may be formed.

A very low content of curable compound(s) having one or more acidic or basic groups (e.g. lower than 20 wt %) is not desirable because a very low charge density may result in a high electrical resistance. A very high content of curable compound(s) having one or more acidic or basic groups is not desirable (e.g. higher than 80 wt %) because then the content of crosslinking agent will be too low.

Hitherto such composite membranes have generally been made in slow and energy intensive processes, often having many stages. The present invention enables the manufacture of composite membranes in a simple process that may be run continuously for long periods of time to mass produce membranes relatively cheaply.

The composite membrane is preferably an anion exchange membrane or a cation exchange membrane.

The thickness of the composite membrane, including the support, is preferably less than 200 μm, more preferably between 10 and 150 μm, most preferably between 20 and 100 μm.

Preferably the composite membrane has an ion exchange capacity of at least 0.3 meq/g, more preferably of at least 0.5 meq/g, especially more than 1.0 meq/g, based on the total dry weight of the membrane and any porous support and any porous strengthening material which remains in contact with the resultant membrane. Ion exchange capacity may be measured by titration as described below in the examples section.

Preferably the composite membrane has a charge density of at least 20 meq/m², more preferably at least 30 meq/m², especially at least 40 meq/m², based on the area of a dry membrane. Charge density may be measured as described above for ion exchange capacity.

Preferably the composite membrane has a permselectivity for small anions (e.g. Cl⁻) of more than 85%, more preferably more than 90% and/or a permselectivity for small cations (e.g. Na⁺) of more than 75%, more preferably of more than 80%, especially more than 85% or even more than 90%.

Preferably the composite membrane has an electrical resistance less than 5 ohm/cm², most preferably less than 3 ohm/cm². The electrical resistance may be determined by the method described below in the examples section.

Preferably the membrane exhibits a swelling in water of less than 50%, more preferably less than 20%, most preferably less than 10%. The degree of swelling can be controlled by selecting appropriate parameters in the curing step.

The water uptake of the composite membrane is preferably less than 50% based on weight of dry membrane, more preferably less than 40%, especially less than 30%.

Electrical resistance, permselectivity and % swelling in water may be measured by the methods described by Djugolecki et al, J. of Membrane Science, 319 (2008) on pages 217-218.

Typically the composite membrane is substantially non-porous e.g. the pores are smaller than the detection limit of a standard Scanning Electron Microscope (SEM). Thus using a Jeol JSM-6335F Field Emission SEM (applying an accelerating voltage of 2 kV, working distance 4 mm, aperture 4, sample coated with Pt with a thickness of 1.5 nm, magnification 100,000×, 3° tilted view) the average pore size is generally smaller than 5 nm, preferably smaller than 2 nm.

The curable composition preferably comprises 25 to 60 wt %, more preferably 35 to 58 wt %, especially 44 to 56 wt % of the crosslinking agent(s) having at least two acrylic groups.

Preferably the wt % of component (a) is >the wt % of component (c).

In one embodiment, the crosslinking agent(s) having at least two (e.g. 2, 3 or 4, preferably 2) acrylic groups also have one or more groups selected from acidic groups, basic groups and groups which are convertible to acidic or basic groups. In another embodiment component (a) is free from acidic and basic groups, preferably free from acidic groups, basic groups and groups which are convertible to acidic or basic groups.

The curable composition may comprise one or more than one crosslinking agent as component (a). When the curable composition comprises more than one crosslinking agent as component (a), none, one or more than one of such crosslinking agents may have one or more groups selected from acidic groups, basic groups and groups which are convertible to acidic or basic groups.

Preferably the crosslinking agent has three or, more preferably, two acrylic groups.

In a particularly preferred embodiment component (a) consists of crosslinking agent(s) having two acrylic groups and component (b) consists of curable compound(s) having one acrylic group.

Generally component (a) provides strength to the composite membrane, while potentially reducing flexibility.

Component (a) preferably has a group adjacent to at least one (preferably all) of its acrylic groups which is hydrophobic and/or sterically hinders that acrylic group, especially when the acrylic group is an acrylate group. For example, component (a) preferably comprises at least one, more preferably at least two, acrylic groups of Formula (I):

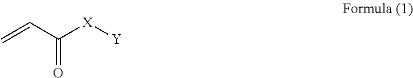

wherein:

X is O or NR¹;

R¹ is H or C₁₋₄-alkyl; and

Y is a secondary or tertiary carbon atom.

Preferably X is O or NH.

Secondary carbon atoms are carbon atoms attached through single covalent bonds to two other carbon atoms. Tertiary carbon atoms are carbon atoms attached through single covalent bonds to three other carbon atoms. In a preferred embodiment Y is a secondary carbon atom attached through single covalent bonds to two other carbon atoms and at least one of the said other carbon atoms is a tertiary carbon atom.

The preference for component (a) having a an acrylic group which is adjacent to a hydrophobic and/or sterically hindered group arises because the presence of such components can increase the resistance of the resultant composite membrane to hydrolysis.

A particularly preferred crosslinking agent having a group adjacent to at least one of the acrylic groups which is hydrophobic and/or sterically hinders that acrylic group (i.e. of Formula (1)) is tricyclodecane dimethanol diacrylate.

Optionally component (a) has one or more acidic or basic groups or groups which are convertible to acidic or basic groups, although preferably component (a) is free from such groups.

In an alternative embodiment, X is NR¹, R¹ is as hereinbefore defined and Y is a primary, secondary or tertiary carbon atom or a carbon atom attached to no other carbon atoms (e.g. as in methylenebisacrylamide where Y is —CH₂—).

Single carbon atoms are carbon atoms not attached to other carbon atoms. Primary carbon atoms are carbon atoms attached through a single covalent bond to one other carbon atom. Another preferred crosslinking agent where X is NR¹, R¹ is as hereinbefore defined and Y is a primary carbon atom, is 1,4-bisacryloylpiperazine.

The curable composition preferably comprises 30 to 75 wt %, more preferably 40 to 70 wt %, especially 42 to 58 wt %, more especially 44 to 56 wt %, of the curable compound(s) having one or more acidic or basic groups or groups which are convertible to acidic or basic groups. Preferably such compounds contain one (and only one) acrylic group.

Preferably the wt % of component (b) is >the wt % of component (c).

Preferably the number of parts of component (b) is from 80 to 400, more preferably 90 to 250, especially 90 to 150 per 100 parts of component (a), wherein all parts are by weight.

The curable composition may comprise one or more than one curable compound having one or more acidic or basic groups or groups which are convertible to acidic or basic groups as component (b).

When component (b) has only one acrylic group (e.g. one H₂C═CHCO₂— or H₂C═CHCON<group) it is unable to crosslink. However it is able to react with component (a). Component (b) can provide the resultant composite membrane with a desirable degree of flexibility, which is particularly useful in applications requiring tightly wound membranes. Component (b) also assists the composite membrane in distinguishing between ions of different charges by the presence of acidic or basic groups.

Preferred acidic groups are carboxy groups and phosphato groups. These groups may be in the free acid or salt form, preferably in the free acid form.

Examples of curable compounds having acidic groups include acrylic acid, beta carboxy ethyl acrylate, maleic acid, maleic acid anhydride, phosphonomethylated acrylamide, carboxy-n-propylacrylamide and (2-carboxyethyl)acrylamide.

Preferred basic groups are secondary amine and tertiary amine groups. Such secondary and tertiary amine groups can be in any form, for example they may be cyclic or acyclic. Cyclic secondary and tertiary amine groups are found in, for example, imidazoles, indazoles, indoles, triazoles, tetrazoles, pyrroles, pyrazines, pyrazoles, pyrrolidinones, triazines, pyridines, pyridinones, piperidines, piperazines, quinolines, oxazoles and oxadiazoles.

Examples of curable compounds having basic groups include N,N-dialkyl amino alkyl acrylates, e.g. dimethylaminoethyl acrylate and dimethylaminopropyl acrylate and N,N-dialkyl amino alkyl acrylamides, e.g. dimethylaminopropyl acrylamide, and butylaminoethyl acrylate.

The groups which are convertible to acidic groups include hydrolysable ester groups.

The groups which are convertible to basic groups include haloalkyl groups (e.g. chloromethyl, bromomethyl, 3-bromopropyl etc.). Haloalkyl groups may be reacted with amines to give basic groups. Examples of compounds having groups which are convertible into basic groups include methyl 2-(bromomethyl)acrylate, ethyl 2-(bromomethyl)acrylate, tert-butyl a-(bromomethyl)acrylate, isobornyl a-(bromomethyl)acrylate, 2-bromo ethyl acrylate, 2-chloroethyl acrylate, 3-bromopropyl acrylate, 3-chloropropyl acrylate, 2-hydroxy-3-chloropropyl acrylate and 2-chlorocyclohexyl acrylate.

Preferably however the curable compound (b) comprises one or more acrylic groups and one or more substituents selected from acidic groups and basic groups. In view of the foregoing statements that component (a) may have one or more acidic or basic groups or groups which are convertible to acidic or basic groups and component (b) may have more than one acrylic group it is possible for components (a) and (b) to both be materials having one or more acidic or basic groups or groups which are convertible to acidic or basic groups and more than one acrylic group. Thus it is even possible for components (a) and (b) to be identical, although it is preferred for them to be different.

Thus in a preferred embodiment, component (a) comprises a crosslinking agent having two acrylic groups and one or more groups selected from acidic groups, basic groups and groups which are convertible to acidic or basic groups, and component (b) comprises a curable compound having one acrylic group and one or more groups selected from acidic groups, basic groups and groups which are convertible to acidic or basic groups.

Generally speaking, the curable composition preferably comprises 5 to 25 wt %, more preferably 12 to 23 wt %, of component (c).

We have found that including the defined amount of solvent in the curable composition can facilitate application of the curable composition to the support whilst also providing composite membranes having desirable properties. The solvent is preferably selected such that when mixed with the other components of the curable composition a stable homogeneous mixture forms which does not phase separate upon curing.

The facilitated application of the curable composition through use of the defined amount of solvent often results in membranes having little or no defects, even when the membranes are very thin. Other desirable characteristics may also arise such as good flexibility, low curling and good durability. Low curling is important for the manageability and handling of the membrane. Thinner layers are not only cost effective but also have a lower electrical resistance without adversely affecting permselectivity.

The solvent is preferable water, an organic solvent or a mixture comprising water and an organic solvent.

When the solvent comprises both water and organic solvent, the organic solvent preferably comprises one or more water-miscible organic solvents.

Preferred organic solvents include diacetone alcohol, dimethyl sulphoxide, esters (e.g. ethyl acetate), C₁-C₄ alcohols (e.g. methanol, ethanol and propan-2-ol), carbonates (e.g. ethylene carbonate, propylene carbonate, dimethyl carbonate, diethyl carbonate, di-t-butyl dicarbonate and glycerin carbonate), dimethyl formamide, N-methyl-2-pyrrolidinone and mixtures comprising two or more thereof.

In a preferred embodiment, the solvent is or comprises diacetone alcohol, dimethylsulphoxide or a mixture comprising diacetone alcohol and dimethylsulphoxide.

Preferably the solvent comprises at least 50%, more preferably at least 75%, especially 100% organic solvent. This preference arises because the presence of organic solvents can result in superior permselectivity to the use of water alone.

The optimum solvent content for the curable composition depends to some extent on the interaction between the solvent, the curable compound(s) and the crosslinking agent(s), and can be determined for each combination by experimentation. The solvents and other components can be varied and the properties of the resultant composite membrane can be measured and compared.

More specifically, when the solvent is dimethylsulphoxide, the preferred solvent content from a curl perspective is 2.5 to 10 wt %, especially 3 to 8 wt %, more especially 3 to 7 wt %. In contrast, when the solvent is the less polar diacetone dialcohol, the preferred solvent content from a curl perspective is 2.5 to 25 wt %, especially 5 to 25 wt %, more especially 10 to 25 wt %, with particularly good results in the range 12 to 23 wt %.

When hydrophilic crosslinking agents are used, solvent polarity influences curl to a lesser extent than when the crosslinking agent is hydrophobic.

Preferably component (c) has a boiling point above 90° C., more preferably above 100° C. The use of such solvent having relatively high boiling point results in little premature evaporation during performance of the process, resulting in a robust production process and providing composite membranes of consistent properties.

Preferably component (c) has a dielectric constant of less than 70 at 293K and 1 atmosphere pressure.

The curable composition preferably comprises 0.01 to 7 wt %, more preferably 0.05 to 5 wt %, especially 0.1 to 2 wt % photoinitiator(s).

The curable composition may comprise one or more than one photoinitiator as component (d).

For acrylates, diacrylates, and higher-acrylates, type I photoinitiators are preferred. Examples of type I photoinitiators are as described in WO 2007/018425, page 14, line 23 to page 15, line 26, which are incorporated herein by reference thereto. Especially preferred photoinitiators include alpha-hydroxyalkylphenones, e.g. 2-hydroxy-2-methyl-1-phenyl propan-1-one and 2-hydroxy-2-methyl-1-(4-tert-butyl-) phenylpropan-1-one, and acylphosphine oxides, e.g. 2,4,6-trimethylbenzoyl-diphenylphosphine oxide, and bis(2,4,6-trimethylbenzoyl)-phenylphosphine oxide.

The curable composition optionally contains (e) 0 to 20 wt %, preferably 4 to 10 wt %, of curable compound(s) having one acrylic group and no acidic or basic groups or groups which are convertible to acidic or basic groups.

The curable composition may contain other components, for example acids, pH controllers, preservatives, viscosity modifiers, stabilisers, dispersing agents, inhibitors, antifoam agents, organic/inorganic salts, anionic, cationic, non-ionic and/or amphoteric surfactants and the like in accordance with the objects to be achieved.

The curable composition may of course contain further components not specifically mentioned above.

Curing rates may be increased by including an amine synergist in the curable composition. Suitable amine synergists are, for example, free alkyl amines, e.g. triethylamine or triethanol amine; aromatic amines, e.g. 2-ethylhexyl-4-dimethylaminobenzoate, ethyl-4-dimethylaminobenzoate and also polymeric amines as polyallylamine and its derivatives.

Curable amine synergists such as ethylenically unsaturated amines (e.g. acrylated amines) are preferable since their use will give less odour due to their ability to be incorporated into the membrane by curing and also because they may contain a basic group which can be useful in the final (anion permeable) membrane.

The amount of amine synergist is preferably from 0.1 to 10 wt. % based on the total weight of polymerisable components in the composition, more preferably from 0.3 to 3 wt. %.

Where desired, a surfactant or combination of surfactants may be included in the composition as a wetting agent or to adjust surface tension. Commercially available surfactants may be utilized, including radiation-curable surfactants. Surfactants suitable for use in the composition include non-ionic surfactants, ionic surfactants, amphoteric surfactants and combinations thereof.

Preferred surfactants are as described in WO 2007/018425, page 20, line 15 to page 22, line 6, which are incorporated herein by reference thereto. Fluorosurfactants are particularly preferred, especially Zonyl® FSN (produced by E.I. Du Pont).

Preferably the components of the curable composition are selected such that no phase separation occurs during the curing step. In this way, the likelihood of curl in the resultant composite membrane is reduced.

The network structure of the membrane is determined to a large extent by the identity of the crosslinking agent(s) and the curable compound and their functionality, e.g. the number of crosslinkable groups they contain per molecule.

The acidic groups are preferably weakly acidic groups and the basic groups are preferably weakly basic groups.

Acrylic groups are of the formula H₂C═CH—C(═O)—. Preferred acrylic groups are acrylate (H₂C═CH—C(═O)—O—) and acrylamide (H₂C═CH—C(═O)—N<) groups.

Preferably the curable composition is substantially free from water (e.g. less than 5 wt %, more preferably less than 1 wt %), because water may negatively affect the properties of the resultant membrane. Furthermore the permselectivity of the resultant composite membrane may also be improved by the absence of water. The word ‘substantially’ is used because it is not possible to rule out the presence of trace amounts of water in the components used to make the composition (because they are unlikely to be perfectly dry).

To achieve a composite membrane having a limited swelling degree (water uptake less than 50%) the crosslinking density should not be too low. This may be achieved by using a relatively high amount of crosslinking groups per unit weight, e.g. by using multifunctional (i.e. functionality>2) crosslinking agents or by using difunctional crosslinking agents of which the functional groups are not very far apart, e.g. by using a compound of limited molecular weight. In one embodiment the crosslinking agents present in the composition all have a molecular weight of at most 350 per acrylic group.

Examples of curable compounds having one acrylic group include dimethylaminopropyl acrylamide (which has a basic group) and 2-hydroxyethyl acrylate, polyethylene glycol monoacrylate, hydroxypropyl acrylate, polypropylene glycol monoacrylate, 2-methoxyethyl acrylate, 2-phenoxyethyl acrylate (which have neither acidic or basic groups) and combinations thereof.

Examples of suitable crosslinking agent(s) comprising two acrylic groups include poly(ethylene glycol) diacrylate, bisphenol-A epoxy acrylate, bisphenol A ethoxylate diacrylate, tricyclodecane dimethanol diacrylate, neopentyl glycol ethoxylate diacrylate, propanediol ethoxylate diacrylate, butanediol ethoxylate diacrylate, hexanediol diacrylate, hexanediol ethoxylate diacrylate, poly(ethylene glycol-co-propylene glycol) diacrylate, poly(ethylene glycol)-block-poly(propylene glycol)-block-poly(ethylene glycol) diacrylate, a diacrylate of a copolymer of polyethylene glycol and other building blocks e.g. polyamide, polycarbonate, polyester, polyimid, polysulfone, and combinations thereof. Other suitable crosslinking agents comprising two acrylic groups are isophorone diacrylamide, N,N′-(1,2-dihydroxyethylene)bis-acrylamide, N,N-methylene-bis-acrylamide, N,N′-ethylenebis(acrylamide), bis(aminopropyl)methylamine diacrylamide. Particularly preferred crosslinking agents are tricyclodecane dimethanol diacrylate, 1,4-diacryoyl piperazine and 1,4-bis(acryloyl)homopiperazine.

Examples of suitable crosslinking agent(s) comprising more than two acrylic groups include glycerol ethoxylate triacrylate, trimethylolpropane ethoxylate triacrylate, trimethylolpropane ethoxylate triacrylate, pentaerythrytol ethoxylate tetraacrylate, ditrimethylolpropane ethoxylate tetraacrylate, dipentaerythrytol ethoxylate hexaacrylate, 1,3,5-triacryloylhexahydro-1,3,5-triazine, 2,4,6-triallyloxy-1,3,5-triazine, and combinations thereof.

The permeability to ions can be influenced by the swellability of the composite membrane and by plasticization. The degree of swelling can be controlled by the types (e.g. hydrophilicity) and ratio of crosslinking agents and crosslinkable compounds, the extent of crosslinking (exposure dose, photo-initiator type and amount) and by other ingredients.

In one embodiment, the process and composition of the present invention is as described in this specification except that the words “one or more acidic groups, basic groups or groups which are convertible to acidic or basic groups” are replaced by “one or more acidic groups or basic groups”.

Thus in a preferred embodiment the curable composition comprises:
(a) 25 to 60 wt % crosslinking agent(s) having at least two acrylic groups and being free from acidic groups, basic groups and groups which are convertible to acidic or basic groups;
(b) 30 to 75 wt % curable compound(s) having one acrylic group and one or more acidic groups, basic groups or groups which are convertible to acidic or basic groups; (c) 5 to 25 wt % organic solvent(s);
(d) 0.01 to 7 wt % photoinitiator(s); and
(e) 0 to 20 wt % of curable compound(s) having one acrylic group and being free from acidic groups, basic groups and or groups which are convertible to acidic or basic groups.

The preferred amounts of (a) to (e) are as described above or below, as is the preferred water content, organic solvents, absent ingredients etc.

Preferably the number of parts of (a), (b), (c), (d) and (e) (when present) in the aforementioned curable compositions add up to 100. This does not rule out the presence of further, different components, but merely sets the ratio of the mentioned components relative to each other.

Preferably the curable composition is free from, or substantially free from, methacrylic compounds (e.g. methacrylate and methacrylamide compounds), i.e. the composition comprises at most 10 wt % of compounds which are free from acrylic groups and comprise one or more methacrylic groups.

Preferably the curable composition is free from, or substantially free from, compounds having tetralkyl-substituted quaternary ammonium groups.

Preferably the curable composition is free from, or substantially free from, compounds having sulpho groups.

Preferably the curable composition is free from, or substantially free from, divinyl benzene.

Preferably the curable composition is free from, or substantially free from, styrene.

Preferably the curable composition is free from, or substantially free from, dyes and pigments. This is because there is no need to include dyes or pigments in the composition.

Thus the preferred curable composition is free from, or substantially free from, divinyl benzene, dyes, pigments, styrene, methacrylic compounds, compounds having tetralkyl-substituted quaternary ammonium groups and compounds having sulpho groups.

The curable composition may sit on top of the support, or it may permeate wholly or partially into the support. The curable composition may also be applied to both sides of the support to achieve a symmetrical composite membrane.

The process of the present invention may contain further steps if desired, for example washing and/or drying the composite membrane. When the composition comprises curable compounds having groups which are convertible to acidic or basic groups the process may further comprise the step of converting the groups which are convertible to acidic or basic groups into acidic or basic groups. When the composition is free from curable compounds having acidic or basic groups and comprises curable compounds having groups which are convertible to acidic or basic groups the process preferably comprises the step of converting the groups which are convertible to acidic or basic groups into acidic or basic groups. In this way a membrane having acidic or basic groups is obtained.

Before applying the curable composition to the surface of the support, the support may be subjected to a corona discharge treatment, plasma glow discharge treatment, flame treatment, ultraviolet light irradiation treatment, chemical treatment or the like, e.g. for the purpose of improving its wettability and the adhesiveness.

The support may also be treated to decrease its surface energy, e.g. to values below 30 mN/m, preferably below 25 mN/m (e.g. between 2 and 20 mN/m). This can reduce or prevent strike-through when the curable composition is applied.

While it is possible to prepare the composite membrane on a batch basis using a stationary support, to gain full advantage of the invention it is much preferred to prepare the composite membrane on a continuous basis using a moving support. The support may be in the form of a roll which is unwound continuously or the support may rest on a continuously driven belt (or a combination of these methods). Using such techniques the curable composition can be applied to the support on a continuous basis or it can be applied on a large batch basis.

The curable composition may be applied to the support by any suitable method, for example by curtain coating, blade coating, air-knife coating, knife-over-roll coating, slide coating, nip roll coating, forward roll coating, reverse roll coating, dip coating, foulard coating, kiss coating, rod bar coating or spray coating. The coating of multiple layers can be done simultaneously or consecutively. For simultaneous coating of multiple layers, curtain coating, slide coating and slot die coating are preferred.

In one embodiment at least two of the curable compositions are applied to the support, e.g. simultaneously or consecutively. The curable compositions may be applied to the same side of the support or to different sides. Thus the application step may be performed more than once, either with or without curing being performed between each application. When applied to different sides the resultant composite membrane may be symmetrical or asymmetrical and the layers of curable composition may have the same or different thicknesses. When applied to the same side a composite membrane may be formed comprising at least one top layer and at least one bottom layer that is closer to the support than the top layer. In this embodiment the top layer and bottom layer, together with any intervening layers, constitute the membrane and the porous support provides strength to the resultant composite membrane.

Thus in a preferred process, the curable composition is applied continuously to a moving support, more preferably by means of a manufacturing unit comprising a curable composition application station, an irradiation source for curing the composition, a composite membrane collecting station and a means for moving the support from the curable composition application station to the irradiation source and to the composite membrane collecting station.

The curable composition application station may be located at an upstream position relative to the irradiation source and the irradiation source is located at a an upstream position relative to the composite membrane collecting station.

In order to produce a sufficiently flowable curable composition for application by a high speed coating machine, it is preferred that the curable composition has a viscosity below 5000 mPa·s when measured at 35° C., more preferably from 1 to 1500 mPa·s when measured at 35° C. Most preferably the viscosity of the curable composition is from 2 to 500 mPa·s when measured at 35° C. For coating methods such as slide bead coating the preferred viscosity is from 2 to 150 mPa·s when measured at 35° C.

With suitable coating techniques, the curable composition may be applied to a support moving at a speed of over 5 m/min, preferably over 10 m/min, more preferably over 15 m/min, e.g. more than 20 m/min, or even higher speeds, such as 60 m/min, 120 m/min or up to 400 m/min can be reached.

Curing in step (ii) is preferably performed by radical polymerisation, preferably using electromagnetic radiation. The source of radiation may be any source which provides the wavelength and intensity of radiation necessary to cure the composition. A typical example of a UV light source for curing is an D-bulb with an output of 600 Watts/inch (240 W/cm) as supplied by Fusion UV Systems. Alternatives are the V-bulb and the H-bulb from the same supplier.

When no photoinitiator is included in the curable composition, the composition can be cured by electron beam exposure, e.g. using an exposure of 50 to 300 keV. Curing can also be achieved by plasma or corona exposure

During curing the components (a) and (b) polymerise to form a polymeric membrane. The curing may be brought about by any suitable means, e.g. by irradiation and/or heating. Preferably curing occurs sufficiently rapidly to form a membrane within 30 seconds. If desired further curing may be applied subsequently to finish off, although generally this is not necessary.

The curing is preferably achieved thermally (e.g. by irradiating with infrared light) or, more preferably, by irradiating the composition with ultraviolet light or an electron beam.

For thermal curing the curable composition preferably comprises one or more thermally reactive free radical initiators, preferably being present in an amount of 0.01 to 5 parts per 100 parts of curable composition, wherein all parts are by weight.

Examples of thermally reactive free radical initiators include organic peroxides, e.g. ethyl peroxide and/or benzyl peroxide; hydroperoxides, e.g. methyl hydroperoxide, acyloins, e.g. benzoin; certain azo compounds, e.g. α,α′-azobisisobutyronitrile and/or γ,γ′-azobis(γ-cyanovaleric acid); persulfates; peracetates, e.g. methyl peracetate and/or tert-butyl peracetate; peroxalates, e.g. dimethyl peroxalate and/or di(tert-butyl) peroxalate; disulfides, e.g. dimethyl thiuram disulfide and ketone peroxides, e.g. methyl ethyl ketone peroxide. Temperatures in the range of from about 30° C. to about 150° C. are generally employed for infrared curing. More often, temperatures in the range of from about 40° C. to about 110° C. are used.

Preferably curing of the curable composition begins within 60 seconds, more preferably within 15 seconds, especially within 5 seconds and most preferably within 3 seconds, of the composition being applied to the support.

Preferably the curing is achieved by irradiating the curable composition for less than 30 seconds, more preferably less than 10 seconds, especially less than 3 seconds, more especially less than 2 seconds. In a continuous process the irradiation occurs continuously and the speed at which the curable composition moves through the beam of irradiation is mainly what determines the time period of curing.

Preferably the curing uses ultraviolet light. Suitable wavelengths are for instance UV-A (390 to 320 nm), UV-B (320 to 280 nm), UV-C (280 to 200 nm) and UV-V (445 to 395 nm), provided the wavelength matches with the absorbing wavelength of any photoinitiator included in the curable composition.

Suitable sources of ultraviolet light are mercury arc lamps, carbon arc lamps, low pressure mercury lamps, medium pressure mercury lamps, high pressure mercury lamps, swirlflow plasma arc lamps, metal halide lamps, xenon lamps, tungsten lamps, halogen lamps, lasers and ultraviolet light emitting diodes. Particularly preferred are ultraviolet light emitting lamps of the medium or high pressure mercury vapour type. In most cases lamps with emission maxima between 200 and 450 nm are particularly suitable.

The energy output of the irradiation source is preferably from 20 to 1000 W/cm, preferably from 40 to 500 W/cm but may be higher or lower as long as the desired exposure dose can be realized. The exposure intensity is one of the parameters that can be used to control the extent of curing which influences the final structure of the membrane. Preferably the exposure dose is at least 40 mJ/cm², more preferably between 40 and 1500 mJ/cm², most preferably between 70 and 900 mJ/cm² as measured by an High Energy UV Radiometer (UV PowerMap™ from EIT, Inc) in the UV-A and UV-B range indicated by the apparatus. Exposure times can be chosen freely but preferably are short and are typically less than 10 seconds, more preferably less than 5 seconds, especially less than 3 seconds, more especially less than 2 seconds, e.g. between 0.1 and 1 second.

To reach the desired exposure dose at high coating speeds, more than one UV lamp may be used, so that the curable composition is irradiated more than once. When two or more lamps are used, all lamps may give an equal dose or each lamp may have an individual setting. For instance the first lamp may give a higher dose than the second and following lamps or the exposure intensity of the first lamp may be lower. Varying the exposure dose of each lamp may influence the polymer matrix structure and the final crosslink density.

Photoinitiators may be included in the curable composition, as mentioned above, and are usually required when curing uses UV or visible light radiation. Suitable photoinitiators are those known in the art such as radical type, cation type or anion type photoinitiators.

Steps (i) and (ii) are preferably performed at between 10 and 60° C. While higher temperatures may be used, these are not preferred because they can lead to higher manufacturing costs.

Preferred supports are porous, e.g. they may be a woven or non-woven synthetic fabric, e.g. polyethylene, polypropylene, polyacrylonitrile, polyvinyl chloride, polyester, polyamide, and copolymers thereof, or porous membranes based on e.g. polysulfone, polyethersulfone, polyphenylenesulfone, polyphenylenesulfide, polyimide, polyethermide, polyamide, polyamideimide, polyacrylonitrile, polycarbonate, polyacrylate, cellulose acetate, polypropylene, poly(4-methyl 1-pentene), polyinylidene fluoride, polytetrafluoroethylene, polyhexafluoropropylene, polychlorotrifluoroethylene, and copolymers thereof.

Commercially available porous supports are available commercially, e.g. from Freudenberg Filtration Technologies (Novatexx materials) and Sefar AG.

Surprisingly, ion exchange membranes with basic or acidic groups (e.g. tertiary amino, carboxyl and phosphato groups) can exhibit good properties in terms of their permselectivity and conductivity while at the same time being not overly expensive to manufacture by the present process.

When any of the components of the curable composition have groups which are convertible to acidic or basic groups the process preferably comprises the further step of converting such groups into acidic or basic groups, e.g. by a condensation or etherification reaction. Preferred condensation reactions are nucleophilic substitution reactions, for example the membrane may have a labile atom or group (e.g. a halide) which is reacted with a nucleophilic compound having a acidic or basic group to eliminate a small molecule (e.g. hydrogen halide) and produce a membrane having the desired acidic or basic group. An example of a hydrolysis reaction is where the membrane carries side chains having ester groups which are hydrolysed to acidic groups.

The present process allows the preparation of membranes having a desirable degree of flexibility, without being overly flexible or too rigid. The presence of the solvent improves coatability for the curable composition and can provide thin membranes with low numbers of defects, low tendency to curl while retaining good durability in use.

The curable compositions as described in relation to the present invention form a further feature of the present invention. The preferences for such compositions are as described in relation to the process according to the first aspect of the present invention.

According to a second aspect of the present invention there is provided a composite membrane obtained by a process according to the first aspect of the present invention.

The composite membranes according to the second aspect of the present invention preferably have the properties described above in relation to the first aspect of the present invention.

The composite membranes of the invention are particularly useful for ED, (C)EDI, EDR, FTC and RED, although they may also be used for other purposes.

According to a third aspect of the present invention there is provided use of a composite membrane according to the second aspect of the present invention for water purification or for the generation of electricity.

According to a fourth aspect of the present invention there is provided an electrodialysis or reverse electrodialysis unit, an electrodeionization module or a flow through capacitor comprising one or more composite membranes according to the second aspect of the present invention.

Preferably the electrodialysis or reverse electrodialysis unit or the electrodeionization module or the flow through capacitor comprises at least one anode, at least one cathode and one or more composite membranes according to the second aspect of the present invention. Further the unit preferably comprises an inlet for providing a flow of relatively salty water along a first side of a membrane according to the present invention and an inlet for providing a less salty flow water along a second side of the membrane such that ions pass from first side to the second side of the membrane. Preferably the one or more composite membranes of the unit comprise a membrane according to the second aspect of the present invention having acidic groups and a membrane according to the second aspect of the present invention having basic groups.

In a preferred embodiment the unit comprises at least 3, more preferably at least 5, e.g. 36, 64 or up to 500, composite membranes according to the second aspect of the present invention. The composite membrane may for instance be used in a plate-and-frame or stacked-disk configuration or in a spiral-wound design. Alternatively, a continuous first membrane according to the present invention having acidic or basic groups may be folded in a concertina (or zigzag) manner and a second membrane having basic or acidic groups (i.e. of opposite charge to the first membrane) may be inserted between the folds to form a plurality of channels along which fluid may pass and having alternate anionic and cationic membranes as side walls. Preferably the second membrane is as defined in relation to the second aspect of the present invention.

The invention will now be illustrated with non-limiting examples where all parts and percentages are by weight unless specified otherwise.

In the examples the following properties were measured by the methods described below:

### General Test Methods

Permselectivity was measured by using a static membrane potential measurement. Two cells are separated by the membrane under investigation. Prior to the measurement the membrane was equilibrated in a 0.1 M NaCl solution for at least 12 hours. Two streams having different NaCl concentrations were passed through cells on opposite sides of the membranes under investigation. One stream had a concentration of 0.1M NaCl (from Sigma Aldrich, min. 99.5% purity) and the other stream was 0.5 M NaCl. The flow rate of both streams was 0.90 dm³/min. Two Calomel reference electrodes (from Metrohm AG, Switzerland) were connected to Haber-Luggin capillary tubes that were inserted in each cell and were used to measure the potential difference over the membrane. The effective membrane area was 3.14 cm² and the temperature was 25° C.

When a steady state was reached, the membrane potential was measured (ΔVₘₑₐₛ)

The permselectivity (α(%)) of the membrane was calculated according the formula:

α(%)=ΔVₘₑₐₛ/ΔVₜₕₑₒᵣ*100%.

The theoretical membrane potential (ΔVₜₕₑₒᵣ) is the potential for a 100% permselective membrane as calculated using the Nernst equation.

Electrical resistance was measured by the method described by Djugolecki et al, J. of Membrane Science, 319 (2008) on page 217-218 with the following modifications:

the auxiliary membranes were CMX and AMX from Tokuyama Soda, Japan;

double headed peristaltic pumps from Watson Marlow (type 504 S/50) were used for the four outer compartments and Verder 2036 gear pumps for the two central compartments;

the flowrate of each stream was 475 ml/min controlled by Porter Instrument flowmeters (type 150AV-B250-4RVS) and Cole Parmer flowmeters (type G-30217-90);

the effective area of the membrane was 3.14 cm².

### Ingredients

DMAPAA is dimethylaminopropyl acrylamide, a curable compound having one acrylic group and a basic group, obtained from Kohjin Chemicals, Japan.
SR833s is tricyclodecane dimethanol diacrylate, a crosslinking agent from Sartomer.
IRG 1870 is Irgacure™ 1870, a photoinitiator from Ciba (Irgacure™ is a trade mark of Ciba).
Additol™ ITX is a photoinitiator from Cytec (Additol™ is a trade mark of Cytec).
Novatexx™ 2426 is a non woven polyester material of weight 64 g/m², thickness 0.14 mm having an air permeability of 750 dm³/m²/s at 200 Pa and density of 0.50 g/cm³ from Freudenberg Filtration Technologies.
DAA is diacetone alcohol.
DMSO is dimethyl sulphoxide.
Zonyl™ FSN100 is a non-ionic fluorosurfactant from Dupont (Zonyl™ is a trade mark of Dupont).

### EXAMPLES 1 to 11 AND COMPARATIVE EXAMPLES 1 TO 3

Curable compositions CC1 to CC11 and comparative curable compositions CE1 to CE3 were prepared by mixing the ingredients shown in Tables 1 and 2:

TABLE 1

| Ingredient | CC1 | CC2 | CC3 | CC4 | CC5 | CC6 | CC7 | CC8 | CC9 | CC10 | CC11 |
|---|---|---|---|---|---|---|---|---|---|---|---|
| DMAPAA | 48.0 | 46.75 | 44.25 | 41.75 | 39.25 | 34.25 | 44.25 | 44.25 | 44.25 | 44.25 | 44.25 |
| SR 833s | 48.0 | 46.75 | 44.25 | 41.75 | 39.25 | 34.25 | 44.25 | 44.25 | 44.25 | 44.25 | 44.25 |
| IRG 1870 | 0.50 | 0.50 | 0.50 | 0.50 | 0.50 | 0.50 | 0.50 | 0.50 | 0.50 | 0.50 | 0.50 |
| Additol ™ ITX | 0.50 | 0.50 | 0.50 | 0.50 | 0.50 | 0.50 | 0.50 | 0.50 | 0.50 | 0.50 | 0.50 |
| DAA | 2.5 | 5.0 | 10.0 | 15.0 | 20.0 | 30.0 | — | — | — | — | — |
| DMSO | — | — | — | — | — | — | 10.0 | — | — | — | — |
| Ethyl acetate | — | — | — | — | — | — | — | 10.0 | — | — | — |
| Methanol | — | — | — | — | — | — | — | — | 10.0 | — | — |
| 2-propanol | — | — | — | — | — | — | — | — | — | 10.0 | — |
| Water | — | — | — | — | — | — | — | — | — | — | 10.0 |
| Zonyl ™ | 0.50 | 0.50 | 0.50 | 0.50 | 0.50 | 0.50 | 0.50 | 0.50 | 0.50 | 0.50 | 0.50 |
| FSN100 | | | | | | | | | | | |
| Viscosity | 42.4 | 36.9 | 31.4 | 24.6 | 20.7 | 14.6 | 21.5 | 14.2 | 13.3 | 18.4 | 63.9 |
| (mPa · s) | | | | | | | | | | | |
| at 35° C. | | | | | | | | | | | |

The high viscosity value of CC11 is thought to be caused by protonation of DMAPAA.

TABLE 2
(Comparative Examples)

| Ingredient | CE1 | CE2 | CE3 |
|---|---|---|---|
| DMAPAA | 49.25 | 29.25 | 24.25 |
| SR833s | 49.25 | 29.25 | 24.25 |
| IRG 1870 | 0.50 | 0.50 | 0.50 |
| Additol ™ ITX | 0.50 | 0.50 | 0.50 |
| DAA | — | 40.0 | 50.0 |
| Zonyl ™ FSN 100 | 0.50 | 0.50 | 0.50 |
| Viscosity (mPa · s) at 35° C. | 47.1 | 12.1 | 10.5 |

Step (i)—Applying the Curable Composition to a Support

The curable compositions described in Tables 1 and 2 were applied to a non-woven support (Novatexx™ 2426) using a slide bead coater at a speed of 20 m/min and leveled using a wire wound rod coater to a thickness of 4 micrometers. The temperature of the curable compositions was 50° C.

Step (ii)—Curing

A membrane was prepared by curing the product of step (i) using a Light Hammer LH6 from Fusion UV Systems fitted with a D-bulb working at 100% intensity with a speed of 20 m/min (single pass). The exposure time was 0.7 seconds.

After curing, the composite membrane was stored in a 0.5 M NaCl solution buffered at pH=4.3 for several days; the storage solution was refreshed every 24 hours until the pH remained below 6.

### Permselectivity and Electrical Resistance Results

The permselectivity and electrical resistance of the resultant composite membranes were measured using the methods described above. The results are as shown in Table 3:

TABLE 3

| Curable | Permselectivity (α (%) ) of | Electrical resistance |
|---|---|---|
| Composition | resultant composite membrane | (ohm/cm²) |
| CC1 | 91.4 | 2.8 |
| CC2 | 91.6 | 3.0 |
| CC3 | 91.2 | 2.8 |
| CC4 | 91.3 | 3.2 |
| CC5 | 90.7 | 3.0 |
| CC6 | 88.4 | 2.7 |
| CC7 | 91.6 | 2.6 |
| CC8 | 92.0 | 2.6 |
| CC9 | 92.2 | 2.3 |
| CC10 | 92.4 | 4.2 |
| CC11 | 81.1 | 3.5 |
| CE1 | 91.7 | 6.1 ** |
| CE2 | 80.6 | 2.3 |
| CE3 | 67.2 | 3.3 |

** variation occurred within the sample and between different samples of the same recipe due to air pockets formed within the cured layer of the composite membrane. These air pockets could be seen clearly in a cross-section of the composite membrane when examined using a scanning electron microscope. The observed variation in electrical resistance was 2.4-6.1 ohm/cm².

Permselectivity higher than 85% is preferred, more preferably higher than 90%.

Electrical resistance lower than 5 ohm/cm² is preferred.

Table 3 shows that CC1 to CC10 containing organic solvents had better permselectivity than CC11 where the solvent was 100% water. The relatively high viscosity of CC11 indicated that some phase inversion had occurred which may have influenced the permselectivity.

### Defect-Free Coating Thickness Results

The curable compositions described in Tables 1 and 2 were applied to a polyethylene coated photographic paper substrate at a speed of 30 m/min using a slide bead coater at a temperature of 50° C. The minimum achievable defect-free wet thickness was measured using each composition and the % reduction in achievable wet coating thickness, relative to comparative Example CE1, is shown in Table 4. The presence of defects was assessed visually, e.g. rivulets were typical when defects were observed.

TABLE 4

| Curable | Solvent content | | Reduction of minimum wet |
|---|---|---|---|
| Composition | (wt %) | | coating thickness (%) |
| CC1 | 2.5% | DAA | 11% |
| CC2 | 5% | DAA | 22% |
| CC3 | 10% | DAA | 33% |
| CC4 | 15% | DAA | 44% |
| CC5 | 20% | DAA | 50% |
| CC6 | 30% | DAA | 61% |
| CE1 | 0% | | 0% |
| CE2 | 40% | DAA | 72% |
| CE3 | 50% | DAA | 78% |

Table 4 shows that increasing the organic solvent content resulted in thinner layers being obtainable before defects occurred.

### Wet Curling Behaviour Results on DAA Compositions

The wet curling behaviour of the composite membranes were measured and the results are shown in Table 5:

TABLE 5

| Curable | Solvent content | | Wet curling |
|---|---|---|---|
| Composition | (wt %) | | behaviour |
| CC1 | 2.5% | DAA | +/− |
| CC2 | 5% | DAA | + |
| CC3 | 10% | DAA | + |
| CC4 | 15% | DAA | ++ |
| CC5 | 20% | DAA | ++ |
| CC6 | 30% | DAA | − * |
| CE1 | 0% | | − |
| CE2 | 40% | DAA | −− * |
| CE3 | 50% | DAA | −− * |

++ no or almost no curling (<5°)
+ slight curling (5 ≧ α ≧ 30°)
+/− medium curling (30 ≧ α ≧ 50°)
− strong curling (50 ≧ α ≧ 70°)
−− very strong curling (≧70°)
* curling became worse due to phase separation in the curable composition.

1. A process for preparing a composite membrane comprising acidic and/or basic groups comprising the following steps:
(i) applying a curable composition to a support; and
(ii) curing the composition by irradiation to form a membrane;
wherein the curable composition comprises:
(a) 18 to 78 wt % crosslinking agent(s) having at least two acrylic groups;
(b) 20 to 80 wt % curable compound(s) having one acrylic group and one or more acidic or basic groups, hydrolysable ester groups or haloalkyl groups;
(c) 2 to 30 wt % solvent(s); and
(d) 0.01 to 7 wt % photoinitiator(s).

2.-33. (canceled)

34. A process according to claim 1 wherein the support is a porous woven or non-woven synthetic fabric or a porous membrane.

35. A process according to claim 1 wherein the crosslinking agent(s) have two acrylic groups.

36. A process according to claim 1 wherein the acidic groups are selected from carboxy and/or phosphato groups and the basic groups are selected from secondary and tertiary amino groups.

37. A process according to claim 1 wherein the support is a porous woven or non-woven synthetic fabric or a porous membrane, the crosslinking agent(s) have two acrylic groups, the acidic groups are selected from carboxy and/or phosphato groups and the said basic groups are selected from secondary and tertiary amino groups.

38. A process according to claim 1 wherein the curable composition is applied continuously to a moving support by means of a manufacturing unit comprising a curable composition application station, an irradiation source for curing the curable composition, a composite membrane collecting station and a means for moving the support from the curable composition application station to the irradiation source and to the composite membrane collecting station.

39. A process according to claim 37 wherein the curable composition is applied continuously to a moving support by means of a manufacturing unit comprising a curable composition application station, an irradiation source for curing the curable composition, a composite membrane collecting station and a means for moving the support from the curable composition application station to the irradiation source and to the composite membrane collecting station.

40. A process according to claim 1 wherein the composition comprises:
(a) 25 to 60 wt % crosslinking agent(s) having at least two acrylic groups and being free from acidic groups, basic groups and groups which are convertible to acidic or basic groups;
(b) 30 to 75 wt % curable compound(s) having one acrylic group and one or more acidic groups, basic groups, hydrolysable ester groups or haloalkyl groups;
(c) 5 to 25 wt % organic solvent(s);
(d) 0.01 to 7 wt % photoinitiator(s); and
(e) 0 to 20 wt % of curable compound(s) having one acrylic group and being free from acidic groups, basic groups and groups which are convertible to acidic or basic groups.

41. A process according to claim 1 wherein the solvent is water, an organic solvent or a mixture comprising water and an organic solvent, wherein the organic solvent comprises diacetone alcohol, dimethylsulphoxide, an ester, a C₁-C₄ alcohol, a carbonate, dimethyl formamide, N-methyl-2-pyrrolidinone, or a mixture comprising two or more thereof.

42. A process according to claim 1 wherein the support is a porous woven or non-woven synthetic fabric or a porous membrane, the solvent is water, an organic solvent or a mixture comprising water and an organic solvent, wherein the organic solvent comprises diacetone alcohol, dimethylsulphoxide, an ester, a C₁-C₄ alcohol, a carbonate, dimethyl formamide, N-methyl-2-pyrrolidinone, or a mixture comprising two or more thereof.

43. A process according to claim 34 wherein the composition comprises:
(a) 25 to 60 wt % crosslinking agent(s) having at least two acrylic groups and being free from acidic groups, basic groups and groups which are convertible to acidic or basic groups;
(b) 30 to 75 wt % curable compound(s) having one acrylic group and one or more acidic groups, basic groups, hydrolysable ester groups or haloalkyl groups;
(c) 5 to 25 wt % organic solvent(s);
(d) 0.01 to 7 wt % photoinitiator(s); and
(e) 0 to 20 wt % of curable compound(s) having one acrylic group and being free from acidic groups, basic groups and groups which are convertible to acidic or basic groups.

44. A curable composition comprising:
(a) 18 to 78 wt % crosslinking agent(s) having two acrylic groups;
(b) 20 to 80 wt % curable compound(s) having one acrylic group and one or more acidic or basic groups, hydrolysable ester groups or haloalkyl groups;
(c) 2 to 30 wt % solvent(s); and
(d) 0.01 to 7 wt % photoinitiator(s).

45. A curable composition according to claim 44 wherein the acidic groups are selected from the group consisting of carboxy groups and phosphato groups and the basic groups are selected from the group consisting of secondary amine and tertiary amine groups.

46. A curable composition according to claim 44 wherein the wt % of component (a) is >the wt % of component (c) and the wt % of component (b) is >the wt % of component (c).

47. A curable composition according to claim 44 wherein the number of parts of component (b) is from 80 to 400 per 100 parts of component (a), wherein all parts are by weight.

48. A composite membrane obtained or obtainable by a process according to claim 1.

49. A composite membrane obtained or obtainable by a process according to claim 44.

50. An electrodialysis or reverse electrodialysis unit, an electrodeionisation module or a flow through capacitor comprising one or more composite membranes according to claim 48.

51. An electrodialysis or reverse electrodialysis unit, an electrodeionisation module or a flow through capacitor comprising one or more composite membranes according to claim 49.
